(19) United States
(12) Patent Application Publication
(10) Pub. No.: US 2018/0053097 A1
(43) Pub. Date: Feb. 22, 2018

(54) METHOD AND SYSTEM FOR MULTI-LABEL PREDICTION

(71) Applicant: YAHOO HOLDINGS, INC., Sunnyvale, CA (US)

(72) Inventors: Akshay Soni, Santa Clara, CA (US); Yashar Mehdad, San Jose, CA (US)

(21) Appl. No.: 15/237,970

(22) Filed: Aug. 16, 2016

(51) Int. Cl. G06N 5/04; G06N 99/00

(52) U.S. Cl. CPC G06N 5/04; G06N 99/005

(57) ABSTRACT

A method implemented on a computing device having at least one processor, storage, and a communication platform connected to a network for multi-label prediction comprises generating a label space; receiving a data point from a user; generating a first feature vector from the data point; projecting the first feature vector to the label space; determining a first set of labels associated with the first feature vector from the label space; converting the first set of labels to a second set of labels; and providing the second set of labels to the user.

### BACKGROUND

### 1. Technical Field

The present teaching relates to method, system and programming for predicting multiple labels associated with datapoints. In particular, the present teaching relates to method, system, and programming for predicting multiple labels associated with datapoints using scalable multi-label learning.

### 2. Discussion of Technical Background

Information propagated on the internet can be represented and annotated in various manners. Text based documents can be truncated into sentences and phrases, which are further represented as feature vectors. Each document may be further annotated with one or more labels, such as tags, named entities, ticker symbols, etc. Annotation or labeling is not limited to text based document; instead, it can be applied to multi-media files such as images or videos and files with specific formatting. An example of those files with specific formatting is bioinformatics data record where gene has to be associated with different functions, entity recommendation and relevance modeling for documents and images on a web-scale resource. Observations indicate that although the label space may be very high dimensional, the relevant labels are often sparse. Auto-labeling of a newly generated data point based on the very high dimensional label space is a difficult task both from scalability and accuracy perspectives.

The task of multi-label learning is to predict a small set of labels associated with each data point out of a space of all possible labels. Interest in multi-label learning problems with large number of labels, features, and data-points has risen due to the applications in the areas of image/video annotation, bioinformatics and entity recommendation described above. More recent applications of multi-label learning are motivated by recommendation and ranking problems. In one application, each search engine query is treated as a label and the task is to get the most relevant queries to a given webpage. Further, specific to Natural Language Processing (NLP) space, developing highly scalable and generalizable classifiers for multi-label text categorization is an important task for a variety of applications, such as relevance modeling, entity recommendation, topic labeling, and relation extraction.

Methods of multi-label learning using dimensionality reduction are employed including compressive sensing (CS), principal component analysis, singular value decomposition and the state-of-the-art low rank empirical risk minimization (LEML) algorithm. There has also been advance made in non-linear dimensionality reduction based multi-label learning approaches such as the X1 algorithm. However, the above mentioned methods or algorithms are still computationally heavy. For example, principal component analysis or singular value decomposition based approaches are challenging to tackle problems involving large number of labels. Compressive Sensing (CS) based approaches, for example, have a very simple and easy dimensionality reduction procedure based on random projections, but require solving a sparse reconstruction problem during prediction which becomes the bottleneck.

Therefore, there is a need to provide a solution to accurately and efficiently recognize and label newly available data points to tackle the above-mentioned challenges.

### SUMMARY

The present teaching relates to method, system and programming for predicting multiple labels associated with datapoints. In particular, the present teaching relates to method, system, and programming for predicting multiple labels associated with datapoints using scalable multi-label learning.

According to an embodiment of the present teaching, a method implemented on a computing device having at least one processor, storage, and a communication platform connected to a network for multi-label prediction comprises generating a label space; receiving a data point from a user; generating a first feature vector from the data point; projecting the first feature vector to the label space; determining a first set of labels associated with the first feature vector from the label space; converting the first set of labels to a second set of labels; and providing the second set of labels to the user.

In some embodiments, generating a label space further comprises obtaining a plurality of data samples from at least a knowledge base; generating a plurality of second feature vectors respectively associated with the plurality of data samples; extracting one or more second labels associated with the plurality of second feature vectors; generating a first label matrix based on the plurality of second feature vectors and the one or more second labels; transforming the first label matrix to a second label matrix; training one or more parameters associated with the second label matrix; and generating the label space based on the second label matrix and the trained one or more parameters.

In some embodiments, each element of the first label matrix indicates a relation as to whether one of the plurality of second vectors is annotated by one of the one or more second labels.

In some embodiments, transforming the first label matrix to a second label matrix further comprises performing dimensionality reduction on the first label matrix based on random rejection, wherein a first dimension of the first label matrix representing a number of labels is reduced to a pre-determined value in the second label matrix.

In some embodiments, the one or more parameters associated with the second label matrix is trained by a least square regression model.

In some embodiments, the first feature vector is projected to the label space using the one or more parameters associated with the second label matrix.

In some embodiments, determining a first set of labels associated with the first feature vector from the label space further comprises selecting a pre-determined number of candidates from the label space using k-nearest neighbor learning; computing an empirical distribution for each of the pre-determined number of candidates; and determining the first set of labels based on the computed empirical distributions.

According to another embodiment of the present teaching, a system having at least one processor, storage, and a communication platform connected to a network for multi-label prediction comprises a multi-label learning engine implemented on the at least one processor and configured to generate a label space; a first feature extractor implemented on the at least one processor and configured to generate a first feature vector from a data point received from a user; a projecting unit implemented on the at least one processor and configured to project the first feature vector to the label space; a predicting unit implemented on the at least one processor and configured to determine a first set of labels associated with the first feature vector from the label space; a label generator implemented on the at least one processor and configured to convert the first set of labels to a second set of labels; and a presenting unit implemented on the at least one processor and configured to provide the second set of labels to the user.

According to another embodiment of the present teaching, a non-transitory machine-readable medium having information recorded thereon for multi-label prediction, wherein the information, when read by the machine, causes the machine to perform the following: generating a label space; receiving a data point from a user; generating a first feature vector from the data point; projecting the first feature vector to the label space; determining a first set of labels associated with the first feature vector from the label space; converting the first set of labels to a second set of labels; and providing the second set of labels to the user.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary system diagram of providing multi-label prediction, according to an embodiment of the present teaching;

FIG. 2 illustrates an exemplary flowchart of providing multi-label prediction, according to an embodiment of the present teaching;

FIG. 3 illustrates an exemplary system diagram of a multi-label learning engine, according to an embodiment of the present teaching;

FIG. 4 illustrates an exemplary flowchart of multi-label learning, according to an embodiment of the present teaching;

FIG. 5 illustrates an exemplary system diagram of a multi-label predicting engine, according to an embodiment of the present teaching;

FIG. 6 illustrates an exemplary flowchart of predicting multiple labels for a new data point, according to an embodiment of the present teaching;

FIG. 7 illustrates a network environment of providing multi-label prediction, according to an embodiment of the present teaching;

FIG. 8 illustrates a network environment of providing multi-label prediction, according to another embodiment of the present teaching;

FIG. 9 depicts a general mobile device architecture on which the present teaching can be implemented; and

FIG. 10 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present teaching leverages the advantages of both Compressive Sensing based approaches and the non-linear X1 algorithm. The approach according to the present teaching benefits from a simple random projection based dimensionality reduction technique during training and the use of k-nearest neighbors (kNN) based approach during inference. The approach according to the present teaching is built based on the fact that the number of labels in a data-point is significantly smaller than the total number of labels, making the label vectors sparse. During training, the present teaching exploits the inherent sparsity in the label space by using random projections as a means to reduce the dimensionality of the label space. By the virtue of Restricted Isometry Property (RIP) which is satisfied by many random ensembles, the distances between the sparse label vectors are approximately preserved in the low-dimensional space. Given the training feature vectors, the low-dimensional labels are predicted by solving a least-squares problem. Further, during inference for a new data point, the present teaching uses the output of the least-squares problem to estimate the corresponding low-dimensional label vector, and further uses the kNN algorithm in the low-dimensional label space to find the k-closest label vectors. As such, the labels that occur for a pre-determined times in these k-closest label vectors are selected as the estimated labels for the new data point. Another novel feature of the present teaching is that it clusters the training data into multiple clusters and applies the RIP based multi-label learning (RIPML) to each cluster separately. Given the advantage of the Restricted Isometry Property (RIP), RIP based multi-label learning provides scalable embedding based approach that tackles the problem of inherent extreme sparsity in the label space for multi-label learning.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

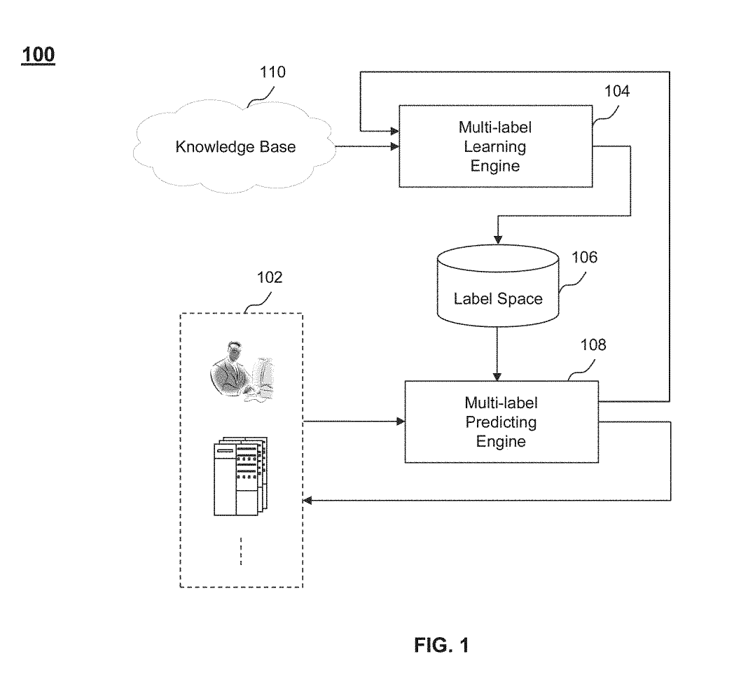

FIG. 1 illustrates an exemplary system diagram of providing multi-label prediction, according to an embodiment of the present teaching. The system of providing multi-label prediction comprises a multi-label learning engine 104, a label space 106, and a multi-label predicting engine 108. Multi-label learning engine 104 is configured to explore the established knowledge base corresponding to a vast amount of data source and pre-generates a database of labels. Each data point may be annotated or tagged with one or more labels. Each label on the contrary, may also be associated with one or more data points. Knowledge base 110 includes information related to user online activities such as tagging, annotating, bookmarking, etc. Such information is collected from all types of online sources that allow the user's activities to be associated with the data points published on the online sources, for example, Wikipedia, Facebook, Twitter, CNN news, etc. Label space 106 stores all the labels and the associated data points in the user-defined formats. When a new data point is received from a user 102, multi-label predicting engine 108 predicts one or more labels associated with the new data point based on the information stored in label space 106 and provides the predicted labels to the user. In some embodiments, new data points are detected once a new article is published on a website. Multi-label predicting engine 108 automatically labels or annotates the new data points based on the information stored in label space 106 such that the labels or annotations are presented together with the published new article.

It should be appreciated that the data points according to the present teaching, are any type of information that can be represented as vectors including text-based documents, images, videos, protein sequences, etc.

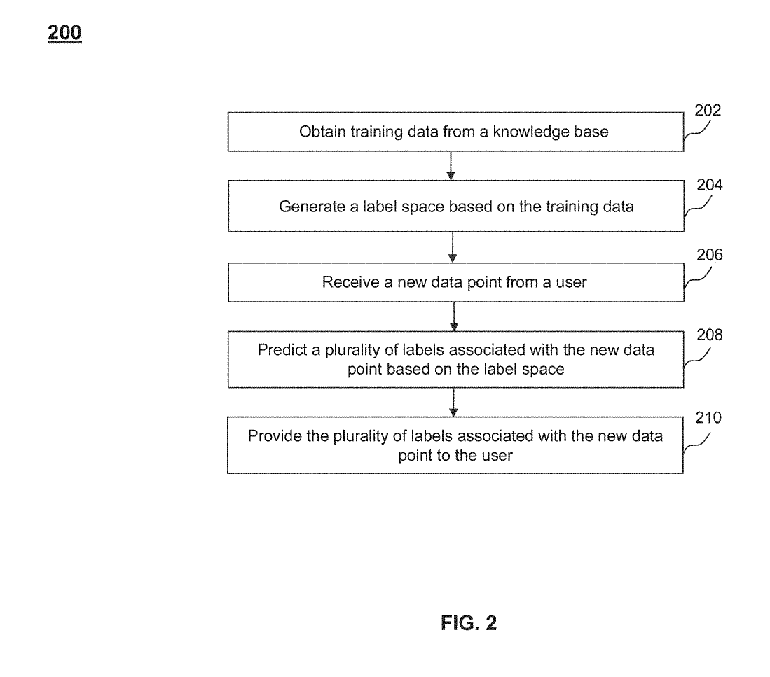

FIG. 2 illustrates an exemplary flowchart of providing multi-label prediction, according to an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 2 and described below is not intended to be limiting.

At operation 202, training data is obtained from a knowledge base. In some embodiments, operation 202 is performed by a multi-label learning engine the same as or similar to multi-label learning engine 104 shown in FIG. 1 and described herein. At operation 204, a label space is generated based on the training data. In some embodiments, operation 204 is performed by a multi-label learning engine the same as or similar to multi-label learning engine 104 shown in FIG. 1 and described herein. At operation 206, a new data point is received from a user. In some embodiments, operation 206 is performed by a multi-label predicting engine the same as or similar to multi-label predicting engine 108 shown in FIG. 1 and described herein. At operation 208, a plurality of labels associated with the new data point is predicted based on the label space. In some embodiments, operation 208 is performed by a multi-label predicting engine the same as or similar to multi-label predicting engine 108 shown in FIG. 1 and described herein. At operation 210, the plurality of labels associated with the new data point is provided to the user. In some embodiments, operation 210 is performed by a multi-label predicting engine the same as or similar to multi-label predicting engine 108 shown in FIG. 1 and described herein.

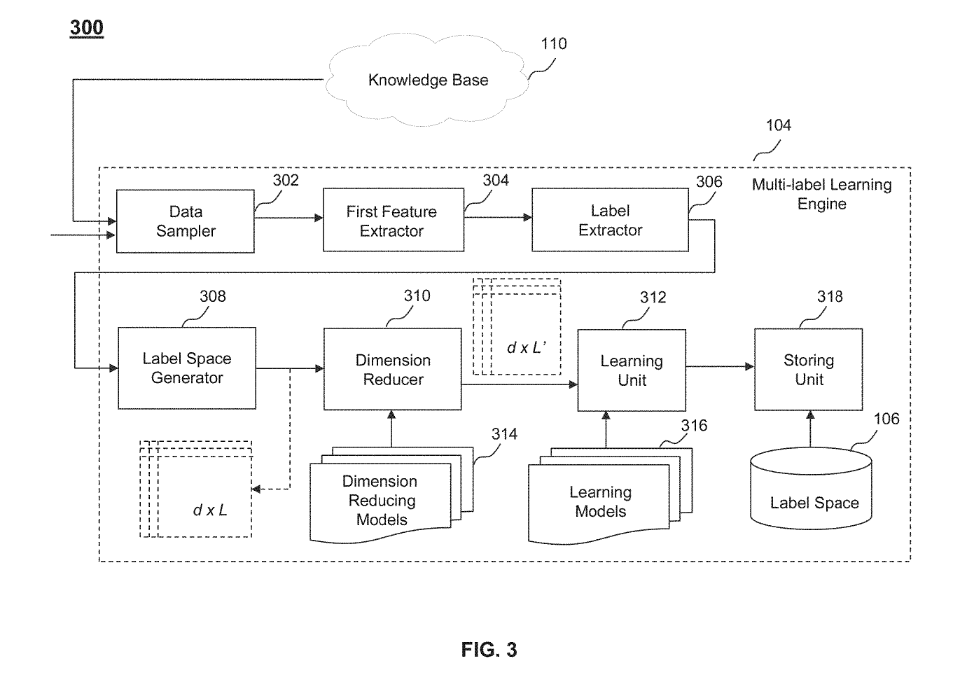

FIG. 3 illustrates an exemplary system diagram of a multi-label learning engine, according to an embodiment of the present teaching. Multi-label learning engine 104 shown in FIG. 1 comprises a data sampler 302, a first feature extractor 304, a label extractor 306, and a label space generator 308. Data sampler 302 is configured to collect training data from knowledge base 110 in accordance with one or more pre-determined criteria. For example, data sampler 302 may collect the articles published on a website according to a temporal schedule, i.e., daily, weekly, monthly, etc. In another example, data sampler 302 may collect the news published on a website and associated with the topics or categories of interest. In yet another example, data sampler 302 may collect the training data according to a spatial area, i.e., Facebook pages for users residing in North America, Europe, etc. Data sampler 302 may also utilize a combination of one or more criteria described above to collect training data from knowledge base 110. First feature extractor 304 is configured to extract all features from the collected training data and construct a feature vector. In some embodiments, a feature vector is a d-dimensional vector of numerical values in which each numerical value represents an object exhibiting in the collected training data. For example, when a feature vector represents images, the numerical values may correspond to the pixels of an image. In yet another example, when a feature vector represents texts, the numerical values may correspond to term occurrence frequencies. Label extractor 306 is configured to extract one or more labels associated with the extracted features and construct an L-dimensional label vector. The initially extracted labels may have duplicate because one label may be applied to multiple data points. Label extractor 306 filters out the duplicate copies of the labels such that each element of the label vector represents a unique label. Label space generator 308 is configured to generate a d by L matrix, where dimension d represents the features and dimension L represents the labels. The value in the d by L matrix denotes a relation between a feature and a label. For example, if the element {i,j} has a numerical value “1,” feature i is at least once tagged or annotated with label j. In the alternative, if the element {i,j} has a numerical value “0,” feature i is not tagged or annotated with label j.

The dimensions of the label space {d, L} may vary each time the training data is extracted. In addition, the dimensions of the label space may be tremendous. For example, in Wikepedia, the free Internet encyclopedia editable to users, there may be more than a million labels/tags/categories created by the users. When a new article is published on Wikepedia, a back-end labeling engine (the same as or similar to multi-label predicting engine 108 shown in FIG. 1) may automatically label or annotate the new article using the label space created for Wikepedia. However, the auto-labeling of a newly published article is less efficient due to the large dimension of the label space.

In some embodiments, multi-label learning engine 104 may further comprise a dimension reducer 310 and a learning unit 312 to perform data training and generate a label space for future label prediction. Dimension reducer 310 is configured to perform a dimension reduction on the label space to generate a lower-dimensional label space. The lower-dimensional label space has the same dimension d representing the features but lower dimension L′ representing the labels (L′<<L). Further, even the label space is projected to a lower-dimensional label space, the relation between the feature and the label is approximately preserved. By performing the dimension reduction on the label space, the least relevant labels are filtered out. One or more dimension reducing models 314 may be selected to perform the dimension reduction including but not limited to compressive sensing (CS), principal component analysis, singular value decomposition, and the state-of-the-art low rank empirical risk minimization (LEML) algorithm, and non-linear dimensionality reduction based multi-label learning approach such as X1 algorithm. The present teaching may also apply a Restricted Isometry Property (RIP) for dimension reduction. Learning unit 312 is configured to train one or more parameters associated with the selected dimension reducing model using the training data and one of the learning models 316, for example, using a least square regression model.

Restricted Isometry Property (RIP) and matrices that satisfy the property are defined as follows:

### Definition

A matrix ΦεR^{m×n} satisfies the (k, δ)−RIP for δε(0,1) if

(1−δ)∥x∥₂²≦∥Φx∥₂²≦(1+δ)∥x∥₂² (1)

For all k-sparse vector xεR′.

Matrices that satisfy RIP may be constructed based on the random matrix theory. For example, random ensembles that satisfy RIP with high probability include Gaussian matrix whose entries are i.i.d.

$$N ( 0 , \frac{1}{m} ) ,$$

i.e., distributed normally with variance of

$$\frac{1}{m} for m = O ( k log ( \frac{n}{k} ) )$$

and Bernoulli matrix with i.i.d. entries over {f1/m} with

$$m = O ( k log ( \frac{n}{k} ) ) .$$

If n is large and k is very small, the only condition that needs to satisfy RIP is m<<n, which provides a very low-dimensional random embedding. If a matrix Φ satisfies (2k,δ)−RIP, then for all k-sparse vectors x and y, Equation (1) becomes:

(1−δ)∥x−y∥₂²≦∥Φ(x−y)∥₂²≦(1+δ)∥x−y∥₂² (2)

Equation (2) indicates that the distance between the projected vectors Φₓ and Φ_{y} is close to the distance between the original vectors x and y. Therefore, the distance property is preserved after the random projections.

In some embodiments, dimension reducer 310 and learning unit 312 implement a first algorithm to project the training label space into a low-dimensional space while approximately preserving the distance between the label vectors. The first algorithm constructs a random matrix ΦεR^{m×L} whose entries are i.i.d.

$$N ( 0 , \frac{1}{m} )$$

and generates a low-dimensional space Z.

Algorithm 1 RIPML: Training

```
Inputs: Training data {(xᵢ, yᵢ), i = 1, 2, ... , N}, embedding dimension m,
regularization parameter λ > 0
Initialize: A Gaussian matrix Φ ∈ R^{m×L}
  $Step 1 \text{:} For each i , {z}_{i} = Φ \frac{{y}_{i}}{{‖ {y}_{i} ‖}^{2}} = Φ {\tilde{y}}_{ι}$
  $Step 2 \text{:} \hat{Ψ} = arg min \frac{1}{2} {‖ Z - Ψ X ‖}_{F}^{2} + λ {‖ Ψ ‖}_{F}^{2}$
Output: Z, \hat{Ψ}
```

In the above description, zᵢεR^{m} is the low-dimensional representation of yᵢ. The above matrix-vector product Φ\tilde{y}ᵢ can be efficiently calculated by adding entries of each row of Φ corresponding to the nonzero locations of yᵢ and then normalizing the result by the square root of number of nonzero entries in yᵢ. If there are s-nonzeros in yᵢ (s<<L), the matrix-vector product Φ\tilde{y}ᵢ can be computed in O(sm) operations rather then O(mL) operations if the label vectors are dense. As the operations are based on the assumption of s<<L, the dimensionality reduction according to the present teaching is more efficient.

Learning unit 312 implements a least square regression model shown in Equation (3) to learn a regression matrix \hat{Ψ}εR^{m×d} for given (xᵢ,zᵢ) such that zᵢ≃Ψₓ_{ᵢ} all iεN.

\hat{Ψ}=argmin½Σᵢ₌₁^{N}(zᵢ−Ψxᵢ)²+λ∥Ψ∥_{F}² (3)

In the above description, λ≧0 is the regularization parameter which controls the Frobenius norm of the regression matrix Ψ. For a reasonable feature dimension d, the present teaching solves Equation (3) in a closed form. Alternatively, any optimization approaches such as the gradient descent can be applied to solve Equation (3) iteratively. Learning unit 312 outputs Z=[z₁, z₂, . . . , z_{N}]εR^{m×N} and Ψ.

It should be appreciated that the algorithms described above are for illustrative purpose. The present teaching is not intended to be limiting. Other random matrices that satisfy the Restricted Isometry Property (RIP) can also be applied to model the low-dimensional space. Further, other linear regression or non-linear regression models may be used to learn the regression matrix W. It should also be appreciated that the components of multi-label learning engine 104 as illustrated in FIG. 3 are for illustrative purpose. Multi-label learning engine 104 may implement more components or modules to be adaptive to the operations.

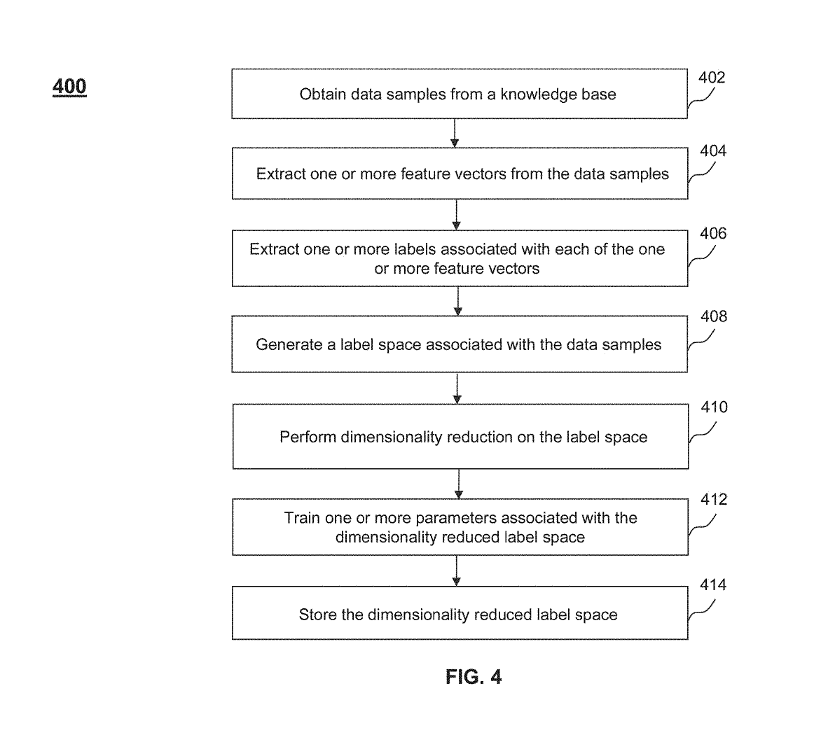

FIG. 4 illustrates an exemplary flowchart of multi-label learning, according to an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 4 and described below is not intended to be limiting. At operation 402, data samples are obtained from a knowledge base. In some embodiments, operation 402 is performed by a data sampler the same as or similar to data sampler 302 shown in FIG. 3 and described herein. At operation 404, one or more feature vectors are extracted from the data samples. In some embodiments, operation 404 is performed by a feature extractor the same as or similar to first feature extractor 304 shown in FIG. 3 and described herein. At operation 406, one or more labels associated with each of the one or more feature vectors are extracted. In some embodiments, operation 406 is performed by a label extractor the same as or similar to label extractor 306 shown in FIG. 3 and described herein. At operation 408, a label space associated with the data samples is generated. In some embodiments, operation 408 is performed by a label space generator the same as or similar to label space generator 308 shown in FIG. 3 and described herein. At operation 410, dimensionality reduction is performed on the label space. In some embodiments, operation 410 is performed by a dimension reducer the same as or similar to dimension reducer 310 shown in FIG. 3 and described herein. At operation 412, one or more parameters associated with the dimensionality reduced label space are trained using the training data. In some embodiments, operation 412 is performed by a learning unit the same as or similar to learning unit 312 shown in FIG. 3 and described herein. At operation 414, the dimensionality reduced label space is stored in a label space. In some embodiments, operation 414 is performed by a storing unit the same as or similar to storing unit 318 shown in FIG. 3 and described herein.

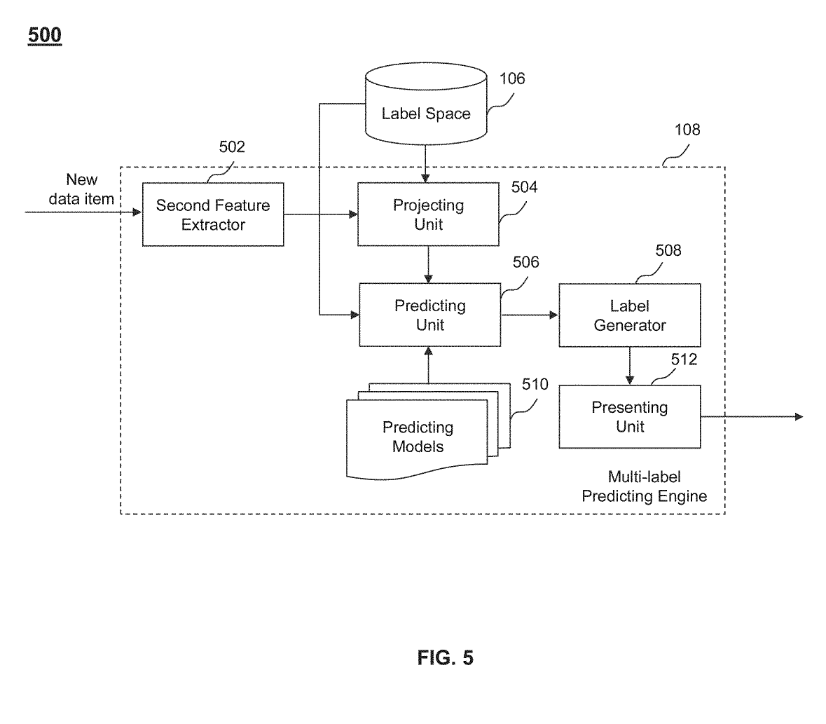

FIG. 5 illustrates an exemplary system diagram of a multi-label predicting engine, according to an embodiment of the present teaching. Multi-label predicting engine 108 shown in FIG. 1 comprises a second feature extractor 502, a projecting unit 504, a predicting unit 506, a label generator 508, and a presenting unit 512. The second feature extractor 502 is configured to extract one or more features from a new data point and construct a feature vector associated with the new data point. The operation of second feature extractor 502 is the same or similar to first feature extractor 302 applied in the multi-label learning engine 104. Projecting unit 504 is configured to project the feature vector associated with the new data point into the pre-generated label space. In some embodiments, the projection of the feature vector to the pre-generated label space is performed using the one or more parameters associated with the dimension reduction model and the pre-generated label space.

Predicting unit 506 is configured to determine a plurality of labels from the pre-generated label space to be applied to the new data point. Predicting unit 506 may apply one of the predicting models 510 to determine the plurality of labels. For example, predicting unit 506 uses the k-nearest neighbors (kNN) algorithm to determine the k-closest label vectors from the pre-generated label space. The determination of a plurality of labels associated with a new data point is described in detail herein below.

Algorithm 2 RIPML: Predicting

```
Inputs: Test point x_{new}, number of desired labels p, number of nearest
neighbors k, Z, \hat{Ψ}, and Y
  Step 1: z_{new} = \hat{Ψ}x_{new}
  Step 2:
  a) {i₁, i₂, ..., iₖ} ← kNN(k) in Z
  $b ) Empirical distribution \text{:} D = \frac{1}{k} {\sum }_{i = {i}_{1}}^{{i}_{k}} {y}_{i}$
  c) ŷ_{new} ← Topₚ(D)
Output: ŷ_{new}
```

Given a new feature vector x_{new}, the above illustrated algorithm outputs one or more labels ŷ_{new} associated with the new feature vector x_{new}. The algorithm first determines the indices of k vectors from Z that are closest to z_{new} in terms of squared distance, and then computes the empirical label distribution

$$D = \frac{1}{k} {\sum }_{i = {i}_{1}}^{{i}_{k}} {y}_{i} .$$

The algorithm selects the top-p locations corresponding to the p highest values as an estimation of the one or more labels associated with the new feature vector x_{new}.

As the one or more labels ŷ_{new} associated with the new feature vector x_{new} are obtained from the low-dimensional label space, label generator 508 converts the one or more labels ŷ_{new} to one or more corresponding labels y_{new} in the original label space (i.e., before dimensional reduction) using the regression matrix W (obtained by multi-label learning engine 104 as illustrated in FIG. 3). Presenting unit 512 is configured to present the one or more labels y_{new} to be displayed to the user. In some embodiments, presenting unit 512 displays the one or more labels y_{new} in different color or font from the other text content. In some other embodiments, presenting unit 512 displays the one or more labels y_{new} in an annotation format that allows auto-displaying further content upon detecting a mouse move or click.

Even though the training according to the present teaching is very simple and scalable, kNN can be slow for datasets with a large number of data points, which increases the training time. Therefore, in some embodiments, the present teaching first clusters the feature vectors into C clusters using k-means clustering or similar clustering techniques. The first algorithm generates a low-dimensional label vectors Z_{c}. and a regression matrix Ψ_{c} for each cluster c. For a new feature vector, the present teaching first determines its cluster membership by searching the closest cluster center, and then applies the first algorithm to compute Z_{c} and Ψ_{c} for each cluster c.

It should be appreciated that the algorithms described above are for illustrative purpose. The present teaching is not intended to be limiting. Other non-parametric methods used for classification and regression may be used to predict the labels for a new data point. It should also be appreciated that the components of multi-label predicting engine 108 as illustrated in FIG. 5 are for illustrative purpose. Multi-label predicting engine 108 may implement more components or modules to be adaptive to the operations.

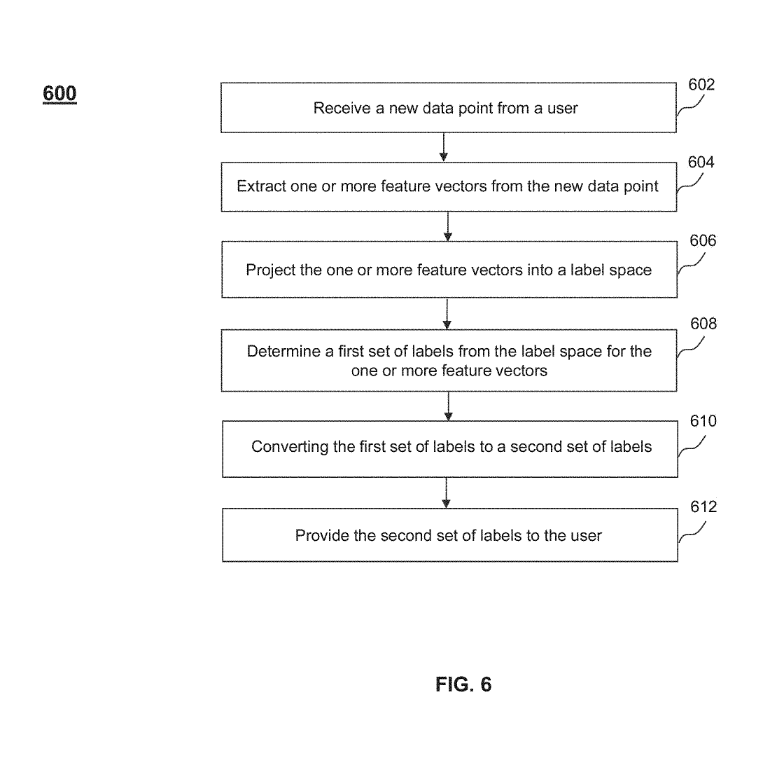

FIG. 6 illustrates an exemplary flowchart of predicting multiple labels for a new data point, according to an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 6 and described below is not intended to be limiting.

At operation 602, new data point is received from a user. At operation 604, one or more feature vectors are extracted from the new data point. In some embodiments, operations 602 and 604 is performed by a feature extractor the same as or similar to second feature extractor 502 shown in FIG. 5 and described herein. At operation 606, the one or more feature vectors are projected to a label space. In some embodiments, operation 606 is performed by a projecting unit the same as or similar to projecting unit 504 shown in FIG. 5 and described herein. At operation 608, a first set of labels from the label space is determined for the one or more feature vectors. In some embodiments, operation 608 is performed by a predicting unit the same as or similar to predicting unit 506 shown in FIG. 5 and described herein. At operation 610, the first set of labels is converted to a second set of labels. In some embodiments, operations 610 is performed by a label generator the same as or similar to label generator 508 shown in FIG. 5 and described herein. At operation 612, the second set of labels is provided to the user. In some embodiments, operation 612 is performed by a presenting unit the same as or similar to presenting unit 512 shown in FIG. 5 and described herein.

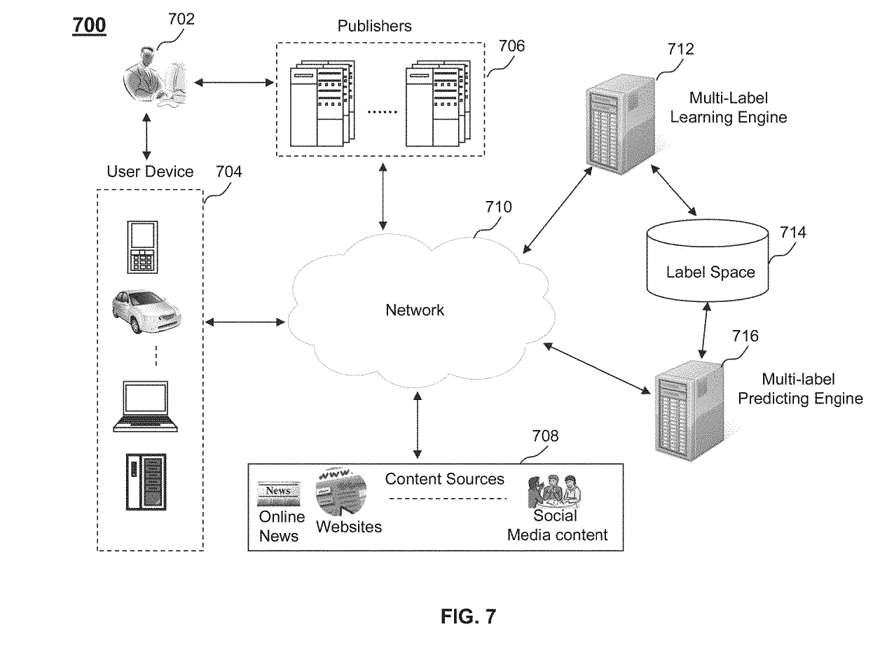

FIG. 7 illustrates a network environment of providing multi-label prediction, according to an embodiment of the present teaching. The exemplary networked environment 700 includes user 702, one or more user devices 704, one or more publishers 706, one or more content sources 708, a network 710, a multi-label learning engine 712, a multi-label predicting engine 716, and a label space 714. One or more user devices 704 are connected to network 710 and include different types of terminal devices including but not limited to desktop computers, laptop computers, a built-in device in a motor vehicle, or a mobile device. One or more publishers 706 are connected to network 710 and include any types of online sources that allow the users to publish the content. One or more publishers 706 may further communicate with one or more content sources 708 to obtain content from all types of media sources. The content resource 708 may correspond to a website hosted by an entity, whether an individual, a business, or an organization such as USPTO.gov, a content provider such as cnn.com and Yahoo.com, a social network website such as Facebook.com, or a content feed source such as tweeter or blogs. Information from the one or more publishers 706 and the one or more content sources 708 are used as a knowledge base for multi-label learning and predicting, the same or similar to knowledge base 110 shown in FIG. 1.

Network 710 may be a single network or a combination of different networks. For example, the network 710 may be a local area network (LAN), a wide area network (WAN), a public network, a private network, a proprietary network, a Public Telephone Switched Network (PSTN), the Internet, a wireless network, a virtual network, or any combination thereof. Network 710 may also include various network access points, e.g., wired or wireless access points such as base stations or Internet exchange points, through which a data source may connect to the network 710 in order to transmit information via the network 710.

Multi-label learning engine 712 periodically retrieves information from the one or more publishers 706 and the one or more content sources 708, and uses the information as a knowledge base to generate and update label space 714. Upon receiving a new data point from user 702 or detecting a new data point being published, multi-label predicting engine 716 predicts a set of labels based on the pre-generated label space 714 to be applied to the new data point.

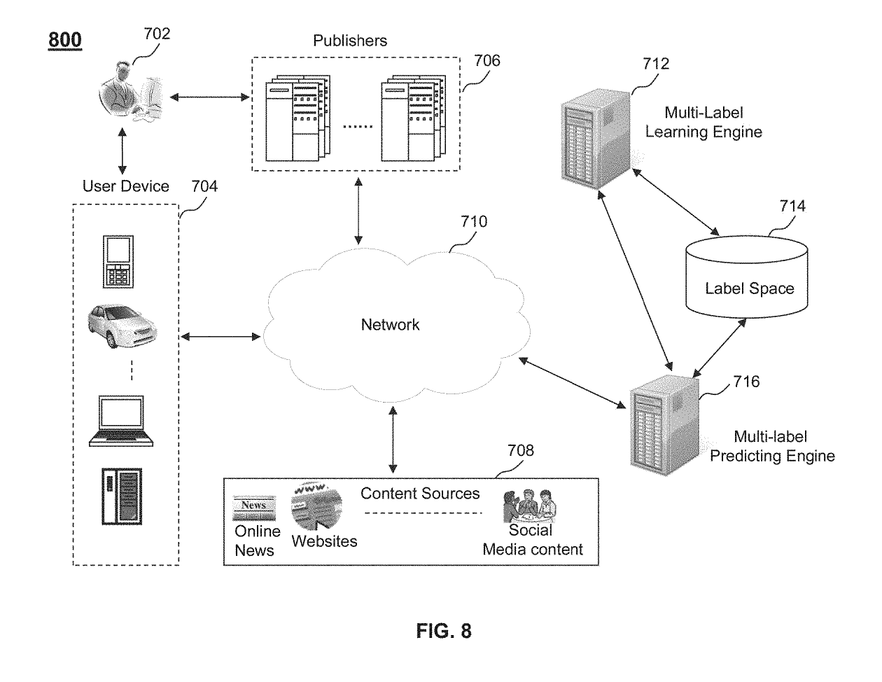

FIG. 8 illustrates a network environment of providing multi-label prediction, according to another embodiment of the present teaching. The networked environment 800 in this embodiment is similar to the networked environment 700 in FIG. 7, except that multi-label learning engine 712 acts as a back-end engine to multi-label predicting engine.

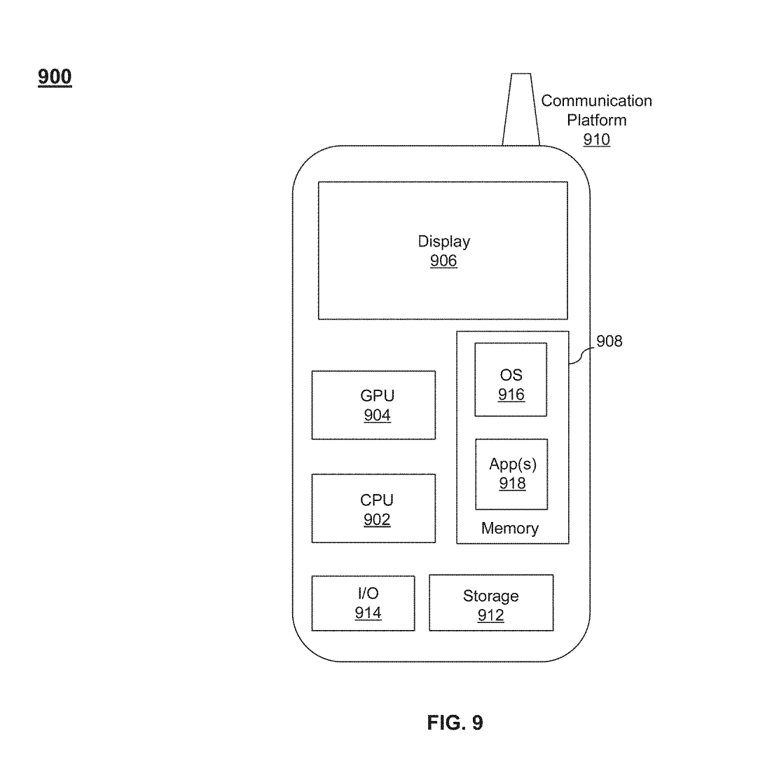

FIG. 9 depicts a general mobile device architecture on which the present teaching can be implemented. In this example, the user device is a mobile device 900, including but is not limited to, a smart phone, a tablet, a music player, a handled gaming console, a global positioning system (GPS) receiver, a smart-TV, wearable devices, etc. The mobile device 900 in this example includes one or more central processing units (CPUs) 902, one or more graphic processing units (GPUs) 904, a display 906, a memory 908, a communication platform 910, such as a wireless communication module, storage 912, and one or more input/output (I/O) devices 914. Any other suitable component, such as but not limited to a system bus or a controller (not shown), may also be included in the mobile device 900. As shown in FIG. 9, a mobile operating system 916, e.g., iOS, Android, Windows Phone, etc., and one or more applications 918 may be loaded into the memory 908 from the storage 912 in order to be executed by the CPU 902. The applications 918 may include a browser or any other suitable mobile apps for receiving labels or tags on an online publication created by users and presenting an article or publication with automatically generated labels or tags through the mobile device 900. Execution of the applications 918 may cause the mobile device 900 to perform the processing as described above in the present teaching. For example, presentation of a new article with automatically generated labels and tags to the user may be made by the GPU 904 in conjunction with the display 906. A label or tag may be inputted by the user via the I/O devices 914.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

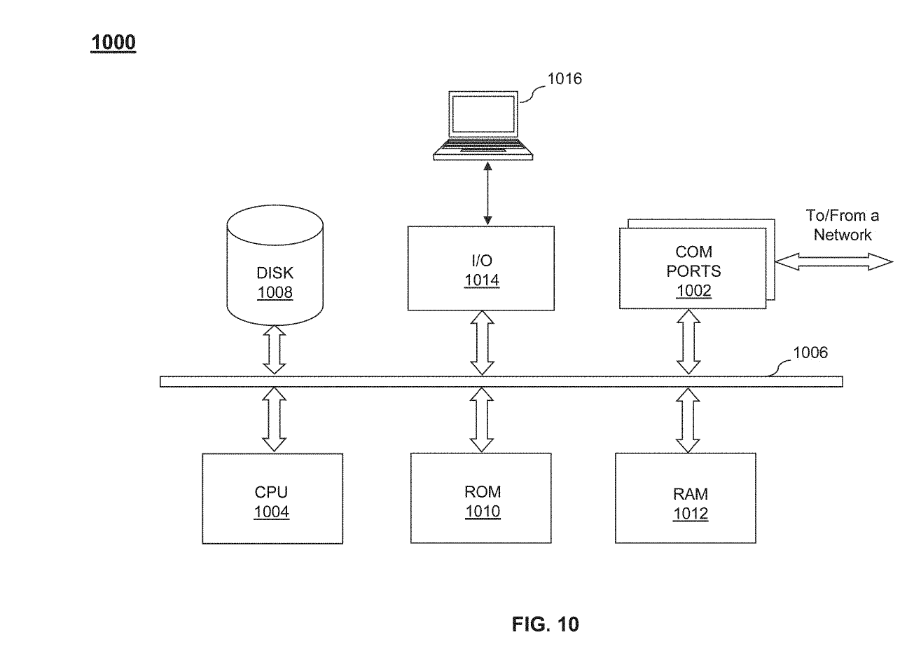

FIG. 10 depicts a general computer architecture on which the present teaching can be implemented. The computer may be a general-purpose computer or a special purpose computer. This computer can be used to implement any components of the system for providing multi-labels prediction as described herein. Different components of the systems disclosed in the present teaching can all be implemented on one or more computers such as computer, via its hardware, software program, firmware, or a combination thereof. Although only one such computer is shown, for convenience, the computer functions relating to content recommendation may be implemented in a distributed fashion on a number of similar platforms, to distribute the processing load.

The computer, for example, includes COM ports 1002 connected to and from a network connected thereto to facilitate data communications. The computer also includes a CPU 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU 1004. The computer also includes an I/O component 1014, supporting input/output flows between the computer and other components therein such as user interface elements 1016. The computer may also receive programming and data via network communications.

Hence, aspects of the methods of user profiling for recommending content, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a computing device having at least one processor, storage, and a communication platform connected to a network for multi-label prediction, the method comprising:
generating a label space;
receiving a data point from a user;
generating a first feature vector from the data point;
projecting the first feature vector to the label space;
determining a first set of labels associated with the first feature vector from the label space;
converting the first set of labels to a second set of labels; and
providing the second set of labels to the user.

2. The method of claim 1, wherein generating the label space further comprises:
obtaining a plurality of data samples from at least a knowledge base;
generating a plurality of second feature vectors respectively associated with the plurality of data samples;
extracting one or more second labels associated with the plurality of second feature vectors;
generating a first label matrix based on the plurality of second feature vectors and the one or more second labels;
transforming the first label matrix to a second label matrix;
training one or more parameters associated with the second label matrix; and
generating the label space based on the second label matrix and the trained one or more parameters.

3. The method of claim 2, wherein each element of the first label matrix indicates a relation as to whether one of the plurality of second vectors is annotated by one of the one or more second labels.

4. The method of claim 2, wherein transforming the first label matrix to a second label matrix further comprises:
performing dimensionality reduction on the first label matrix based on random rejection, wherein a first dimension of the first label matrix representing a number of labels is reduced to a pre-determined value in the second label matrix.

5. The method of claim 2, wherein the one or more parameters associated with the second label matrix is trained by a least square regression model.

6. The method of claim 2, wherein the first feature vector is projected to the label space using the one or more parameters associated with the second label matrix.

7. The method of claim 1, wherein determining a first set of labels associated with the first feature vector from the label space further comprises:
selecting a pre-determined number of candidates from the label space using k-nearest neighbor learning;
computing an empirical distribution for each of the pre-determined number of candidates; and
determining the first set of labels based on the computed empirical distributions.

8. A system having at least one processor, storage, and a communication platform connected to a network for multi-label prediction, the system comprising:
a multi-label learning engine implemented on the at least one processor and configured to generate a label space;
a first feature extractor implemented on the at least one processor and configured to generate a first feature vector from a data point received from a user;
a projecting unit implemented on the at least one processor and configured to project the first feature vector to the label space;
a predicting unit implemented on the at least one processor and configured to determine a first set of labels associated with the first feature vector from the label space;
a label generator implemented on the at least one processor and configured to convert the first set of labels to a second set of labels; and
a presenting unit implemented on the at least one processor and configured to provide the second set of labels to the user.

9. The system of claim 8, wherein the multi-label learning engine implemented on the at least one processor further comprises:
a data sampler configured to obtain a plurality of data samples from at least a knowledge base;
a second feature extractor configured to generate a plurality of second feature vectors respectively associated with the plurality of data samples;
a label extractor configured to extract one or more second labels associated with the plurality of second feature vectors;
a label space generator configured to generate a first label matrix based on the plurality of second feature vectors and the one or more second labels;
a dimension reducer configured to transform the first label matrix to a second label matrix;
a learning unit configured to train one or more parameters associated with the second label matrix, and generate the label space based on the second label matrix and the trained one or more parameters.

10. The system of claim 9, wherein each element of the first label matrix indicates a relation as to whether one of the plurality of second vectors is annotated by one of the one or more second labels.

11. The system of claim 9, wherein the dimension reducer is further configured to:
perform dimensionality reduction on the first label matrix based on random rejection, wherein a first dimension of the first label matrix representing a number of labels is reduced to a pre-determined value in the second label matrix.

12. The system of claim 9, wherein the one or more parameters associated with the second label matrix is trained by a least square regression model.

13. The system of claim 9, wherein the first feature vector is projected to the label space using the one or more parameters associated with the second label matrix.

14. The system of claim 8, wherein the predicting unit is further configured to:
select a pre-determined number of candidates from the label space using k-nearest neighbor learning;
compute an empirical distribution for each of the pre-determined number of candidates; and
determine the first set of labels based on the computed empirical distributions.

15. A non-transitory machine-readable medium having information recorded thereon for multi-label prediction, wherein the information, when read by the machine, causes the machine to perform the following:
generating a label space;
receiving a data point from a user;
generating a first feature vector from the data point;
projecting the first feature vector to the label space;
determining a first set of labels associated with the first feature vector from the label space;
converting the first set of labels to a second set of labels; and
providing the second set of labels to the user.

16. The medium of claim 15, wherein the information, when read by the machine, causes the machine to further perform the following:
obtaining a plurality of data samples from at least a knowledge base;
generating a plurality of second feature vectors respectively associated with the plurality of data samples;
extracting one or more second labels associated with the plurality of second feature vectors;
generating a first label matrix based on the plurality of second feature vectors and the one or more second labels;
transforming the first label matrix to a second label matrix;
training one or more parameters associated with the second label matrix; and
generating the label space based on the second label matrix and the trained one or more parameters.

17. The medium of claim 16, wherein each element of the first label matrix indicates a relation as to whether one of the plurality of second vectors is annotated by one of the one or more second labels.

18. The medium of claim 16, wherein the information, when read by the machine, causes the machine to further perform the following:
performing dimensionality reduction on the first label matrix based on random rejection, wherein a first dimension of the first label matrix representing a number of labels is reduced to a pre-determined value in the second label matrix.

19. The medium of claim 16, wherein the one or more parameters associated with the second label matrix is trained by a least square regression model.

20. The medium of claim 15, wherein the information, when read by the machine, causes the machine to further perform the following:
selecting a pre-determined number of candidates from the label space using k-nearest neighbor learning;
computing an empirical distribution for each of the pre-determined number of candidates; and
determining the first set of labels based on the computed empirical distributions.
